(19) United States
(12) Patent Application Publication
(10) Pub. No.: US 2006/0257241 A1
(43) Pub. Date: Nov. 16, 2006

(54) Screw turbine device

(76) Inventor: Jan Inge Eielsen, Hafrsfjord (NO)

Correspondence Address: KNOBBE MARTENS OLSON & BEAR LLP, 2040 MAIN STREET, FOURTEENTH FLOOR, IRVINE, CA, 92614, US

(21) Appl. No.: 10/543,255

(22) PCT Filed: Jan. 28, 2004
(86) PCT No.: PCT/NO04/00026

§ 371 Date: May 6, 2006

(30) Foreign Application Priority Data
Jan. 30, 2003 (NO) 20030464

(51) Int. Cl. F03B 3/12

(52) U.S. Cl. 415/71

(57) ABSTRACT

A screw turbine device (1) comprising at least one helical blade (4) that is rotatable about an axis (6), the cross section of the blade (4) being in the shape of the profile (15) of an aeroplane wing, and where the aeroplane wing-like profile (15) projects from the outer radial extent of the blade (4) and in to the shaft (2) of the screw turbine (1).

This invention regards a turbine, more particularly a screw turbine suitable for use both in flowing liquids and gas.

The use of windmills is known for the recovery of energy from flowing air. Likewise, there is a large selection of turbines designed to utilize the kinetic energy in flowing water, in particular in connection with power plants where there is a level difference between the reservoir and the turbine.

Windmills of the type used in large wind power plants generate a lot of noise and are thought by many to spoil the landscape. Their reliability however, is satisfactory.

Document GB 2057584 concerns a wind turbine comprising an assemblage of a number of helical rotors. In one embodiment, the turbine blades are constructed with an approximate darrieus shape comprising an aeroplane wing profile arranged at a distance from the axis of rotation of the turbine. WO 01/48374 describes a turbine where the aeroplane wing shaped principal turbine blades disposed at a distance from the axis of rotation of the turbine are provided with further aeroplane wing shaped secondary turbine blades, and where the longitudinal axes of the secondary turbine blades assumes an angle relative to the longitudinal axis of the principal turbine blades.

It has proven difficult to recover kinetic energy from currents in the sea and from wave motion. The reason may be the difficulties associated with dimensioning a plant to resist the large forces to which arrangements of this type are exposed, particularly during bad weather.

The object of the invention is to remedy the disadvantages of prior art.

The object is achieved in accordance with the invention, by the characteristics stated in the description below and in the following claims.

A relatively high efficiency is achieved by placing a screw is turbine having a suitably shaped screw geometry, in a fluid flow.

A screw turbine is constituted by a screw profile wrapped around an axis, wherein the actual screw profile projects radially from the axis with a relatively small cross sectional thickness. The screw profile may have the same or a variable pitch along the axis.

If a fluid flow flows past a screw turbine at approximately the same angle relative to the central axis of the screw turbine as that of the screw pitch, the fluid flow will pass through the screw turbine essentially in parallel with the screw blade of the screw turbine on one side of the central axis, while the fluid flow on the opposite side of the central axis will impinge on the screw blade, where this blade portion presents a pressure face to the fluid flow. Thus the screw turbine is caused to rotate about its own axis. According to the invention, the cross section of the blade is given a geometry similar to that of an aeroplane wing. Thus a cross section of the screw blade parallel to the direction of fluid flow will typically define a profile similar to that of an aeroplane wing, projecting from the central axis.

Most of the torque imparted to a screw turbine according to prior art results from fluid flowing against an area, a pressure face, which assumes an angle relative to the direction of flow, and which is located at a distance from the axis of rotation. With a screw turbine of the invention, where a part of the turbine blade is rotated towards an upstream position relative to the direction of flow, this part may be termed a flow face, torque is also produced by fluid flowing essentially parallel with the aeroplane wing-like profile, whereby a tangential force is imparted to the turbine blade, also before it assumes an angle against the direction of flow.

The pressure and flow faces are moved along the screw turbine during the rotation of the screw turbine. By using of this type of geometry, the efficiency of the screw blade is improved.

The screw turbine may be used at any orientation as long as the direction of fluid flow relative to the central axis of the screw turbine is substantially the same as the screw pitch.

In some applications, e.g. when submerged in water, the screw turbine may be provided with a rotatable mounting. In the case of such an application, the turbine construction may include buoyancy elements that cause the turbine to assume an upward position, and where the current in the water rotates the axis of the turbine to a favourable position relative to the direction of flow. The turbine may also be used suspended from a corresponding suspension, e.g. underneath a moored raft.

The geometry of the turbine blade must be adjusted for among other things fluid viscosity and density for each application.

The shaft of the screw turbine may, in a manner that is known per se, be connected to a generator for generation of electrical power or to another device that requires energy, e.g. a pump.

The following describes a non-limiting example of a preferred embodiment illustrated in the accompanying drawings, in which:

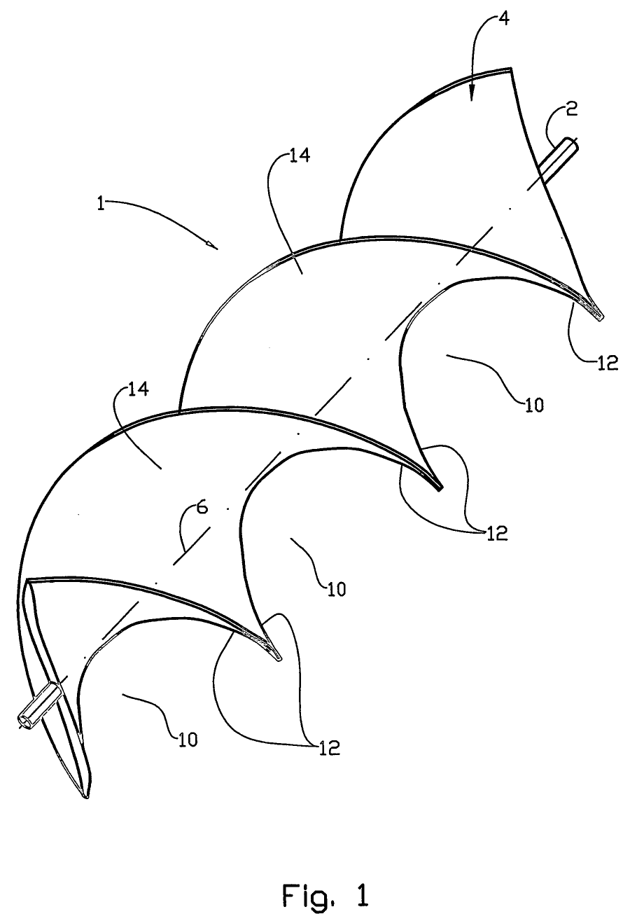

FIG. 1 schematically shows a screw turbine seen from the upstream face of the fluid;

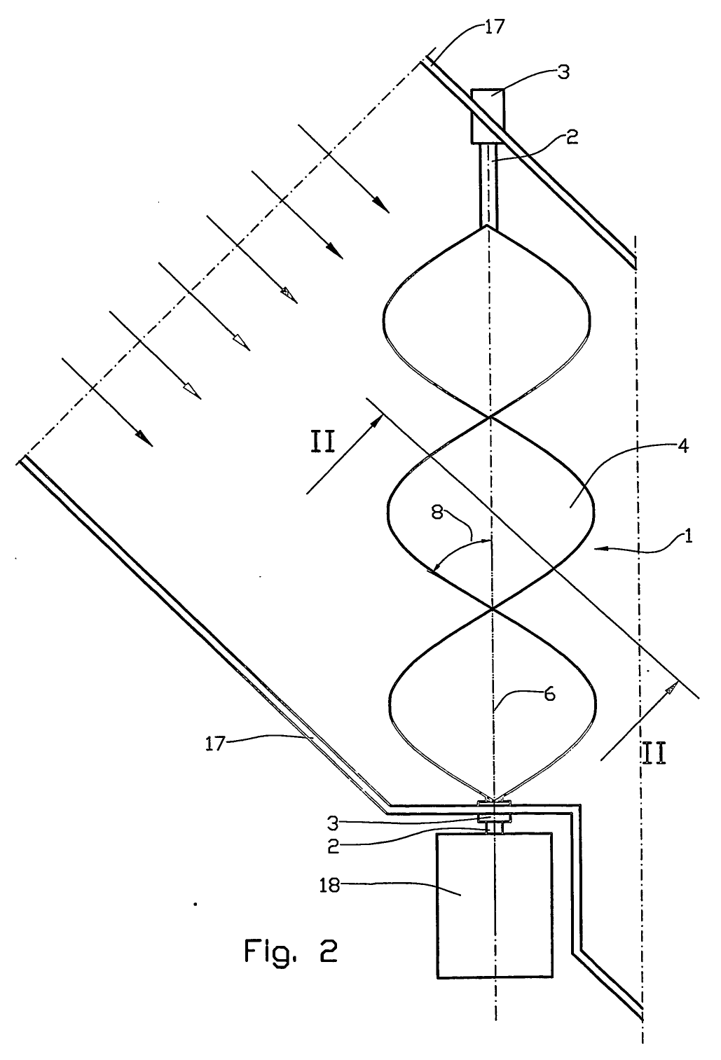

FIG. 2 schematically shows an example embodiment in which the screw turbine is mounted in a fluid flow;

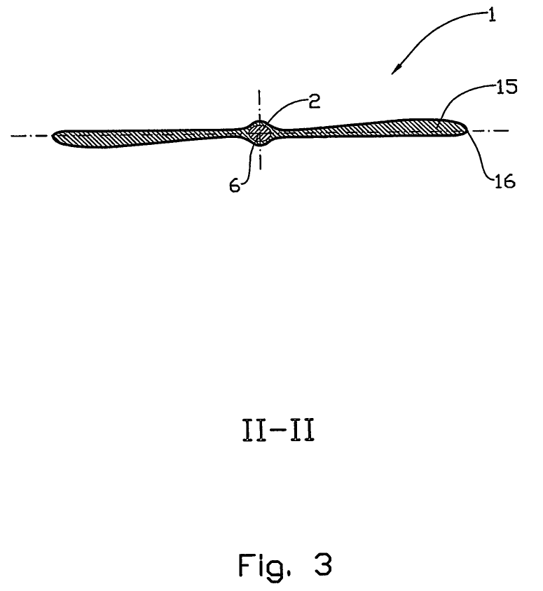

FIG. 3 shows a section II-II in FIG. 2; and

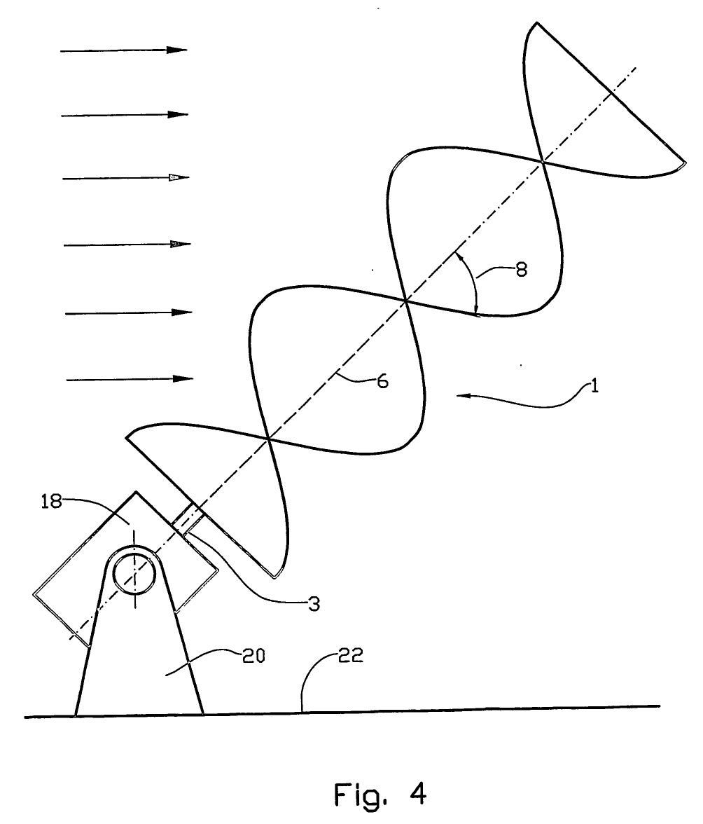

FIG. 4 schematically shows an example embodiment in which the screw turbine is rotatably mounted under water.

In the drawings, reference number 1 denotes a screw turbine comprising a shaft 2, the shaft 2 being rotatably supported in bearings 3, and a helical turbine blade 4.

FIG. 1 shows the screw turbine 1 from the direction of inflow of the fluid flowing through/past the screw turbine 1. In order to achieve a satisfactory efficiency, the direction of flow relative to the central axis 6 of the screw turbine 1 must be approximately equal to the pitch angle 8 of the turbine blade 4, see FIG. 2. The flowing fluid passes, with reference to FIG. 1, on the underside of the central axis 6, through the openings 10 between the parts of the turbine blade 4 positioned in the downward direction, indicated by reference number 12 in FIG. 1.

The portion 14 of the turbine blade projecting upwards from the central axis 6 constitutes an obstruction to flow, and hence is subjected to a pressure force from the flowing fluid when the fluid impinges on the blade portion 14. Thus the screw turbine is caused to rotate about its own central axis 6.

The shape of the cross sectional geometry of the turbine blade 4 has proven to have a significant effect on the hydraulic efficiency of the turbine 1. The highest efficiency is achieved when the cross section of the turbine blade 4 along the direction of flow is constructed with a cross sectional profile 15 like that of an aeroplane wing, see FIG. 2.

The flowing fluid that encounters the turbine blade 4 at the upstream edge 16 of the turbine blade 4 is split, and the fluid flowing along the top surface of the cross sectional profile 15 must, in a manner that is known per se, increase its velocity, whereby the static pressure falls, resulting in a pressure difference between the top surface and the lower surface of the cross sectional profile 15. The pressure difference causes the blade portions of the turbine blade 4 projecting in the upstream direction relative to the direction of fluid flow to be subjected to a lift force that results in additional torque about the axis 2.

In FIG. 2 the screw turbine 1 is mounted in a flow of water. The shaft 2 of the screw turbine 1 is supported by bearings 3 at both ends and is connected to a generator 18. The bearings 3 are coupled to a structure 17. The water flowing against the screw turbine I causes this to rotate, whereby the generator 18 may produce electric energy. The direction of flow is indicated by arrows in FIG. 2.

In a further embodiment, see FIG. 4, the screw turbine 1 is disposed under water. The shaft 2 of the screw turbine 1 is connected to a generator 18 via bearings 3. The screw turbine 1 and the generator 18 are rotatably connected to a foundation 20 on the seabed 22. In this example embodiment, the turbine blade 4 is constructed so as to have sufficient buoyancy. The buoyancy force causes the screw turbine 1 to be raised towards a vertical position, while the force from the flowing fluid rotates the screw turbine 1 in the direction of flow until the screw turbine 1 assumes a favourable orientation relative to the direction of fluid flow. The direction of flow is indicated by arrows in FIG. 4.

In other embodiments, the screw turbine may be mounted in a suspended manner from an appropriate fixture or form part of a bank of turbines.

1. A screw turbine device comprising at least one helical blade that is rotatable about an axis, the cross section of the blade being constructed in the shape of the profile of an aeroplane wing, wherein the aeroplane wing-like profile projects from the outer radial end of the blade and in to the shaft of the screw turbine.

2. A device according to claim 1, wherein the axis of the screw turbine assumes an angle relative to the flowing fluid, which essentially corresponds to the pitch angle of the screw turbine.

3. A device according to claim 1, wherein the screw turbine is rotatably connected to a suspension about an axis that does not coincide with the central axis of the screw turbine.

4. A device according to claim 1 wherein the pitch of the blade varies along the central axis.

5. A device according to claim 2, wherein the pitch of the blade varies along the central axis.

6. A device according to claim 3, wherein the pitch of the blade varies along the central axis.
